(19) United States
(12) Patent Application Publication
(10) Pub. No.: US 2010/0141595 A1
(43) Pub. Date: Jun. 10, 2010

(54) TOUCH DISPLAY PANEL

(75) Inventors: Chih-Chang Lai, Taichung County (TW); Ting-Yu Chang, Kaohsiung County (TW); Ching-Fu Hsu, Taichung County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: WINTEK CORPORATION, Taichung (TW)

(21) Appl. No.: 12/629,051

(22) Filed: Dec. 2, 2009

(30) Foreign Application Priority Data
Dec. 4, 2008 (TW) 97147166

(51) Int. Cl. G06F 3/041; G09G 3/36

(52) U.S. Cl. 345/173; 345/87

(57) ABSTRACT

A touch display panel including scan lines, data lines, pixel units electrically connecting the scan lines and the data lines, at least a sensing-signal line locating between the pixel units, and at least a touch-sensing device is provided. Each touch-sensing element includes a set of sensing pads and a signal transmission element. The set of the sensing pads includes a first pad and a second pad separated from each other. The first pad and the second pad are respectively electrically connected to the scan line and the sensing-signal line. The signal transmission element is located above the set of the sensing pads. When a position where the touch-sensing element is disposed is pressed, the signal transmission element directly contacts the first pad and the second pad. When the position where the touch-sensing element is disposed is unpressed, the first pad and the second pad are electrically insulated.

### CROSS-REFERENCE TO RELATED APPLICATION

This application claims the priority benefit of Taiwan application serial no. 97147166, filed Dec. 4, 2008. The entirety of the above-mentioned patent application is hereby incorporated by reference herein and made a part of specification.

### BACKGROUND OF THE INVENTION

1. Field of the Invention

The present invention relates to a touch display panel. More particularly, the present invention relates to a display panel having a touch control function.

2. Description of Related Art

FIG. 1 is a schematic diagram illustrating a conventional touch display panel. Referring to FIG. 1, the touch display panel 100 includes a plurality of scan lines 102, a plurality of data lines 104, a plurality of pixel units 106, at least a touch scan line 112, at least a touch data line 114 and at least a touch device 116. The scan lines 102 are intersected to the data lines 104, and the pixel units 106 are electrically connected to the scan lines 102 and the data lines 104. Moreover, the touch scan line 112 is approximately parallel to the scan line 102, and the touch data line 114 is approximately parallel to the data lines 104. The touch device 116 is electrically connected to the touch scan line 112 and the touch data line 114.

The touch display panel 100 can implement an image-display function through the pixel units 106, and can also implement a touch-sensing function through the touch device 116. However, to achieve a normal operation of the touch device 116, the touch scan line 112, the touch data line 114 and a related control circuit are generally configured in the touch display panel 100. Therefore, application of the touch scan line 112 and the touch data line 114 complicate a circuit layout of the touch display panel 100. Meanwhile, the touch scan line 112 and the touch data line 114 are generally fabricated by a light-shielding material such as metal, etc, application of the touch scan line 112 and the touch data line 114 further limits a display aperture ratio of the touch display panel 100.

### SUMMARY OF THE INVENTION

The present invention is directed to a touch display panel including a plurality of scan lines, a plurality of data lines, a plurality of pixel units, at least a sensing-signal line and at least a touch-sensing device. The plurality of scan lines is intersected to the plurality of data lines, and the plurality of pixel units is electrically connected to the plurality of scan lines and the plurality of data lines. The sensing-signal line is located between two adjacent pixel units that are belonging to the pixel units. The touch-sensing device includes a set of sensing pads and a signal transmission element. The set of sensing pads includes a first pad and a second pad apart from the first pad. The first pad is electrically connected to one of the scan lines, and the second pad is electrically connected to the sensing-signal line. The signal transmission element is located above the set of sensing pads. When a position where the touch-sensing device is disposed is pressed, the signal transmission element directly contacts the first pad and the second pad. When the position where the touch-sensing element is disposed is unpressed, the signal transmission element is insulated to at least one of the first pad and the second pad.

In an embodiment of the present invention, the touch display panel further includes a scan control circuit, a data control circuit and a sensing control circuit. The scan control circuit is electrically connected to the plurality of scan lines, the data control circuit is electrically connected to the plurality of data lines, and the sensing control circuit is electrically connected to the sensing-signal line.

In an embodiment of the present invention, each of the pixel unit includes an active device and a light-emitting device. Each of the active devices is electrically connected to one of the scan lines and one of the data lines, and the light-emitting device is located on the active device and is electrically connected to the active device. The touch display panel further includes a planarization layer located between the active device and the light-emitting device. A material of the planarization layer is, for example, a flexible insulation material, and in an embodiment, the planarization layer is further located between the signal transmission element and the set of sensing pads. The planarization layer for example has a plurality of grooves, and the signal transmission element is at least located in the grooves.

In an embodiment of the present invention, the touch display panel further includes a scan control circuit, a data control circuit and a sensing control circuit. The scan control circuit is electrically connected to the scan lines, the data control circuit is electrically connected to the data lines, and the sensing control circuit is electrically connected to the sensing-signal line.

In the present invention, one of the pads of the touch-sensing device is connected to the scan line, and a scan signal transmitted by the scan line is served as a touch-sensing signal. Therefore, in the touch display panel of the present invention, at least configuration of the touch scan line can be omitted, which avails simplifying a circuit layout of the touch display panel. Moreover, a simple design of the touch-sensing device can also lead to a better display aperture ratio of the touch display panel.

In order to make the aforementioned and other objects, features and advantages of the present invention comprehensible, a preferred embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a conventional touch display panel.

FIG. 2 is schematic diagram illustrating a part of a touch display panel according to an embodiment of the present invention.

FIG. 3 is a schematic diagram illustrating a touch display panel according to an embodiment of the present invention.

FIG. 4 is a timing diagram of scan signals in scan lines of a touch display panel of the present invention.

FIG. 5A, FIG. 6 and FIG. 7 are cross-sectional views of three touch display panels according to an embodiment of FIG. 2.

FIG. 5B is a schematic diagram illustrating a touch display panel of FIG. 5A when being pressed.

FIG. 8 is a schematic diagram of a touch display panel according to another embodiment of the present invention.

### DESCRIPTION OF EMBODIMENTS

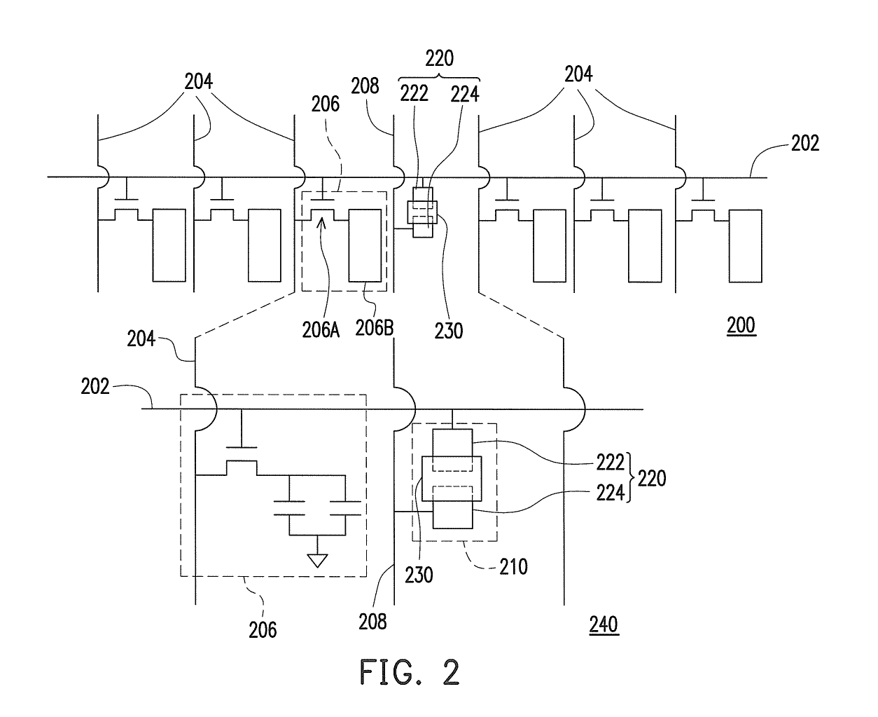

FIG. 2 is schematic diagram illustrating a part of a touch display panel according to an embodiment of the present invention. Referring to FIG. 2, the touch display panel 200 includes a plurality of scan lines 202, a plurality of data lines 204, a plurality of pixel units 206, a plurality of sensing-signal lines 208 and a plurality of touch-sensing devices 210. The scan lines 202 are intersected to the data lines 204, and the pixel units 206 are electrically connected to the scan lines 202 and the data lines 204, wherein only one scan line 202 is illustrated in FIG. 2 for description. Actually, the scan lines 202, the data lines 204 and the pixel units 206 can be disposed on a substrate (not shown). The sensing-signal line 208 is located between two adjacent pixel units that are belonging to the pixel units 206, and only one sensing-signal line 208 is taken as an example in the present embodiment. Each of the touch-sensing devices 210 includes a set of sensing pads 220 and a signal transmission element 230. The set of sensing pads 220 includes a first pad 222 and a second pad 224 apart from the first pad 222. The first pad 222 is electrically connected to one of the scan lines 202, and the second pad 224 is electrically connected to the sensing-signal line 208. The signal transmission element 230 is located above the set of sensing pads 220.

When a position where the touch-sensing device 210 is disposed is pressed, the signal transmission element 230 directly contacts the first pad 222 and the second pad 224. At this time, the first pad 222 can be electrically connected to the second pad 224 through the signal transmission element 230. Therefore, a signal carried on the scan line 202 is transmitted to the second pad 224 and the sensing-signal line 208. Moreover, when the position where the touch-sensing element 210 is disposed is unpressed, the signal transmission element 230 is departed from the first pad 222 and the second pad 224. In other words, when the position where the touch-sensing element 210 is disposed is unpressed, the first pad 222 and the second pad 224 are mutually insulated.

To be specific, the pixel unit 206, for example, includes an active device 206A and a pixel electrode 206B electrically connected to the active device 206A. The active device 206A is electrically connected to the scan line 202 and the data line 204. The pixel units 206 are used for displaying images, and the touch-sensing device 210 is used for performing a touch sensing. A quantity of the touch-sensing device 210 and a configuration density thereof are varied along with different product designs. In an embodiment, each of the touch-sensing devices 210 can correspond to one pixel unit 206, or a plurality of the pixel units 206 may share one corresponding touch-sensing device 210. For example, three pixel units of R, G and B share one corresponding touch-sensing device 210 and one corresponding sensing-signal line 208 (as shown in FIG. 2).

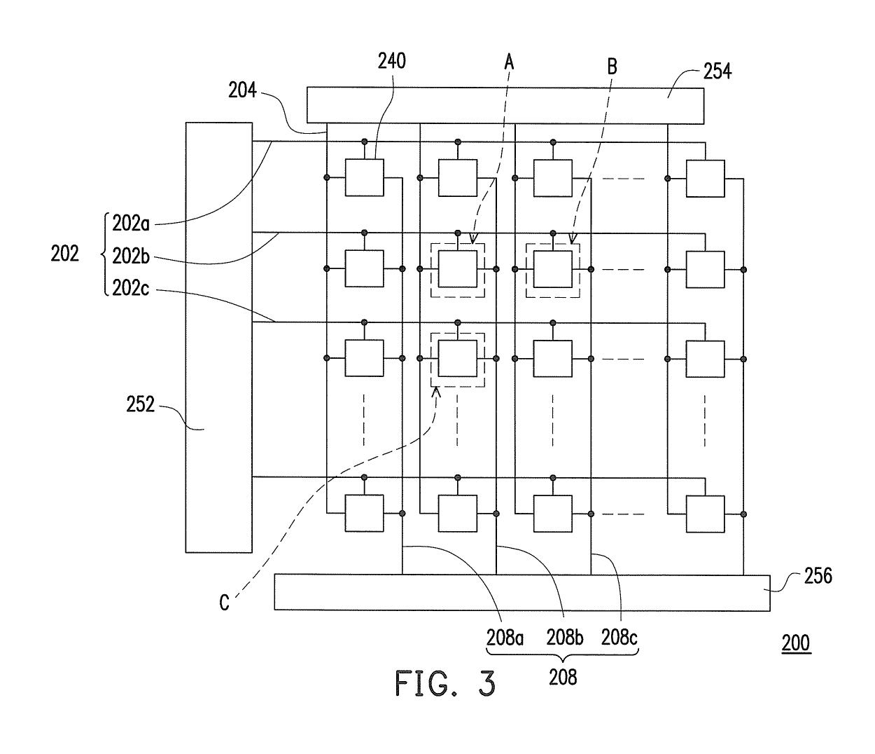

FIG. 3 is a schematic diagram illustrating a touch display panel according to an embodiment of the present invention. Referring to FIG. 2 and FIG. 3, the touch display panel 200 further includes a scan control circuit 252, a data control circuit 254 and a sensing control circuit 256. The scan control circuit 252 is electrically connected to the scan lines 202, the data control circuit 254 is electrically connected to the data lines 204, and the sensing control circuit 256 is electrically connected to the sensing-signal line 208. When the touch display panel 200 displays an image, the scan control circuit 252 sequentially outputs scan signals to each of the scan lines 202, so as to activate the active devices 206A in the pixel units 206. When the active device 206A is turned on, a corresponding data signal output by the data control circuit 254 is written into the pixel electrode 206B. Now, the touch display panel 200 is able to display the image.

Moreover, when the touch display panel 200 is pressed or touched by a user, the touch-sensing device 210 located at a pressed region is correspondingly changed to perform the touch sensing. In the present embodiment, the touch-sensing device 210 and at least one corresponding pixel unit 206 are regarded as a sensing unit 240 to describe the touch sensing operation.

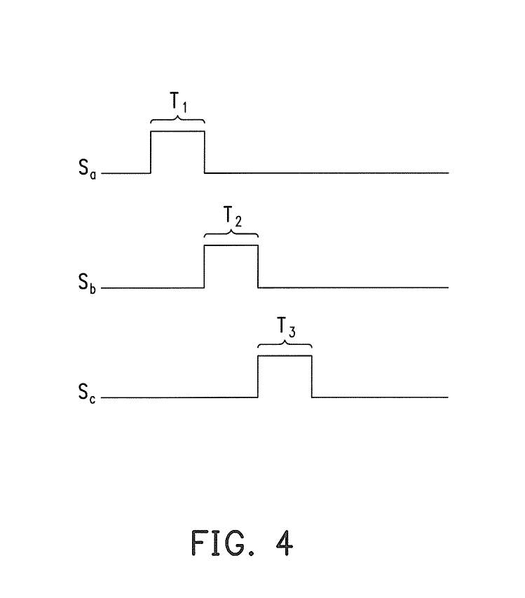

FIG. 4 is a timing diagram of scan signals in each of the scan lines of the touch display panel of the present invention. Referring to FIG. 3 and FIG. 4, when the touch display panel 200 display images, scan signals Sa-Sc are respectively input to three adjacent scan lines 202a-202c. During a time section T1, the scan line 202a has a high level voltage (scan signal Sa), so that the high level voltage (for example 12V-15V) is only input to the sensing unit 240 electrically connected to the scan line 202a. Similarly, during time sections T2 and T3, the high level voltages (scan signals Sb and Sc) are only input to the sensing units 240 electrically connected to the scan lines 202b and 202c, respectively.

When the user touches or presses a position A of the touch display panel 200, the touch-sensing device (not shown) in the corresponding sensing unit 240 is conducted. Therefore, the sensing-signal line 208b receives the high level voltage (for example 12V-15V) carried on the scan line 202b during the time section T2 and stores it into a memory of the sensing control circuit 256. Since other positions on the touch display panel 200 are not touched by the user, the voltage stored in the memory is zero. The sensing control circuit 256 can determine the position A touched by the user according to the time section (T2) during which the high level voltage (12V-15V) is received, and the position of the sensing-signal line 208b that receives the high level voltage.

If the user simultaneously touches the position A and a position B on the touch display panel 200, the sensing-signal lines 208b and 208c then respectively receive the high voltage level at the time section T2. At this time, the sensing control circuit 256 can simultaneously memorize the high level voltages on the two sensing-signal lines 208b and 208c to determine the touched positions A and B. Moreover, if the position A and a position C on the touch display panel 200 are simultaneously touched by the user, the sensing-signal line 208b respectively receives the high level voltage at the time section T2 and the time section T3. The sensing control circuit 256 can still determine the two positions A and C. Further, when the user simultaneously touches the position B and the position C, the sensing control circuit 256 can record the high level voltage on the sensing-signal line 208c during the time section T2, and the high level voltage on the sensing-signal line 208b during the time section T3, so as to determine the touched positions B and C. In brief, the touch display panel 200 has a multi-point touch control function. Therefore, when the touch display panel 200 of the present embodiment is actually applied to electronic products, operations of the electronic products can be more convenient and humanity.

Since additional configuration of a scan circuit related to the touch control is unnecessary for the touch display panel 200, the circuit layout of the touch display panel 200 is simplified. Moreover, since the touch-sensing device 210 of the present embodiment has a small size, a display aperture ratio of the touch display panel 200 is less affected by application of the touch-sensing device 210. In other words, the touch display panel 200 of the present embodiment still has a better display aperture ratio. In addition, when the user simultaneously touches a plurality of positions on the touch display panel 200, the touch display panel 200 can simultaneously detect the touched positions. Namely, the touch display panel 200 has the multi-point touch control function.

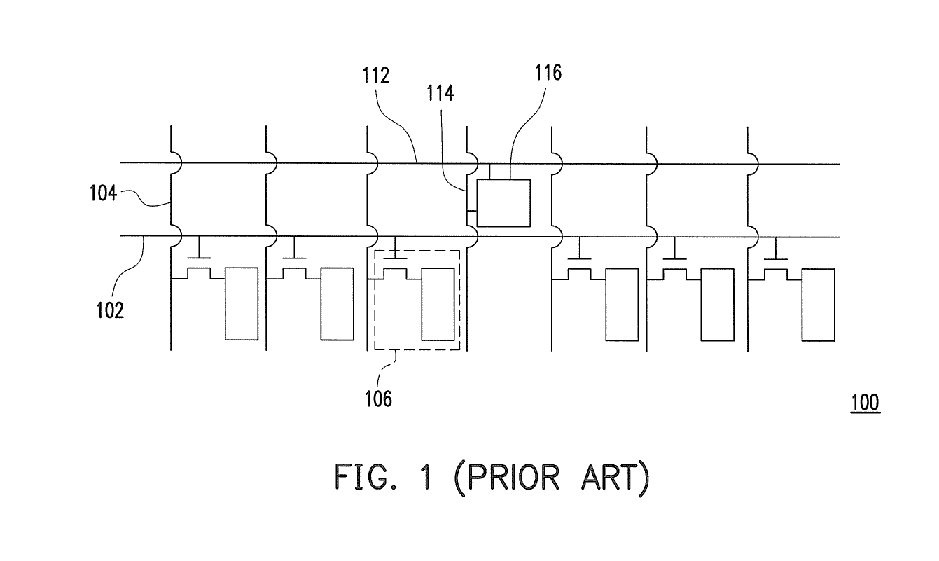

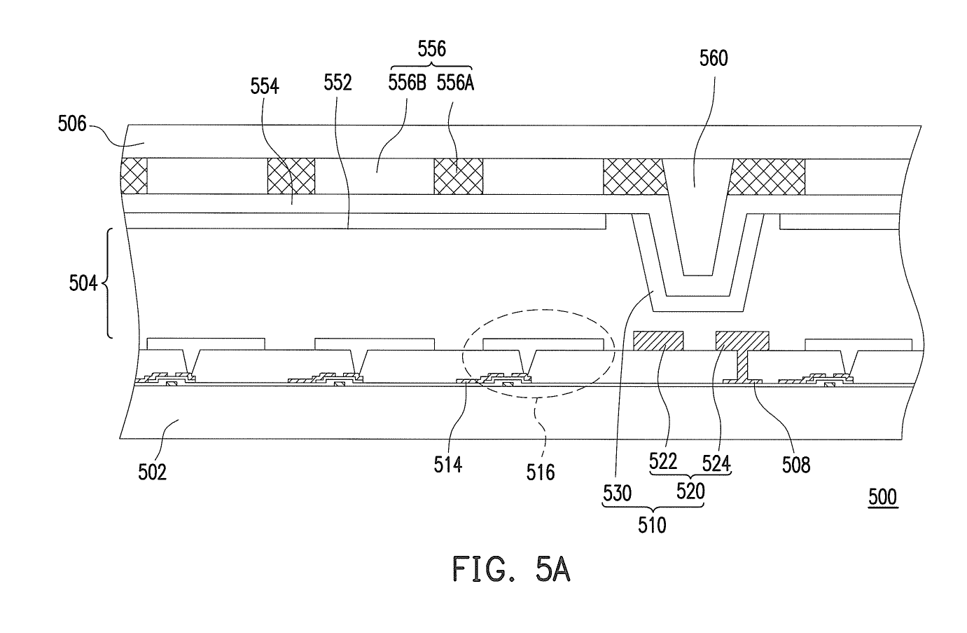

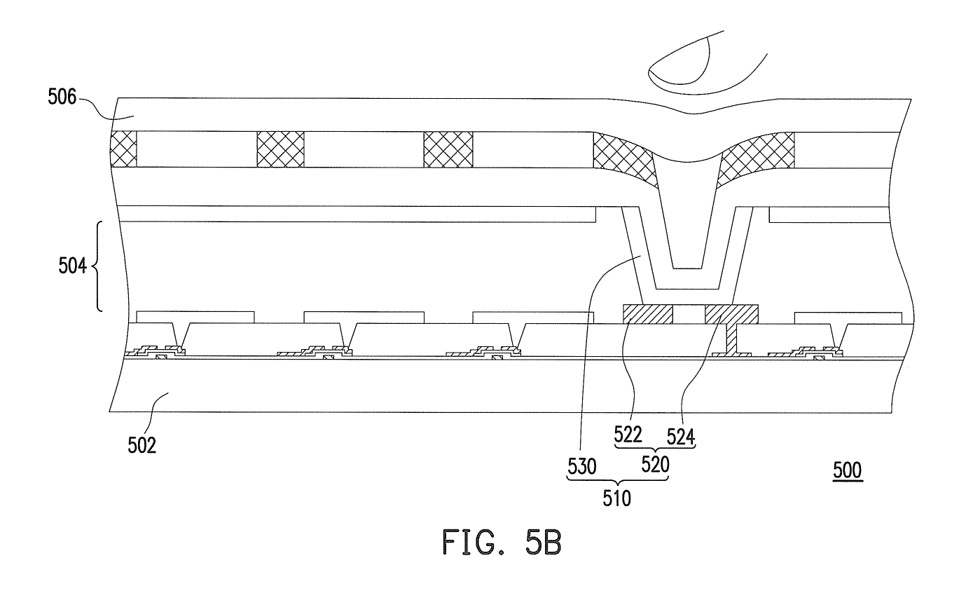

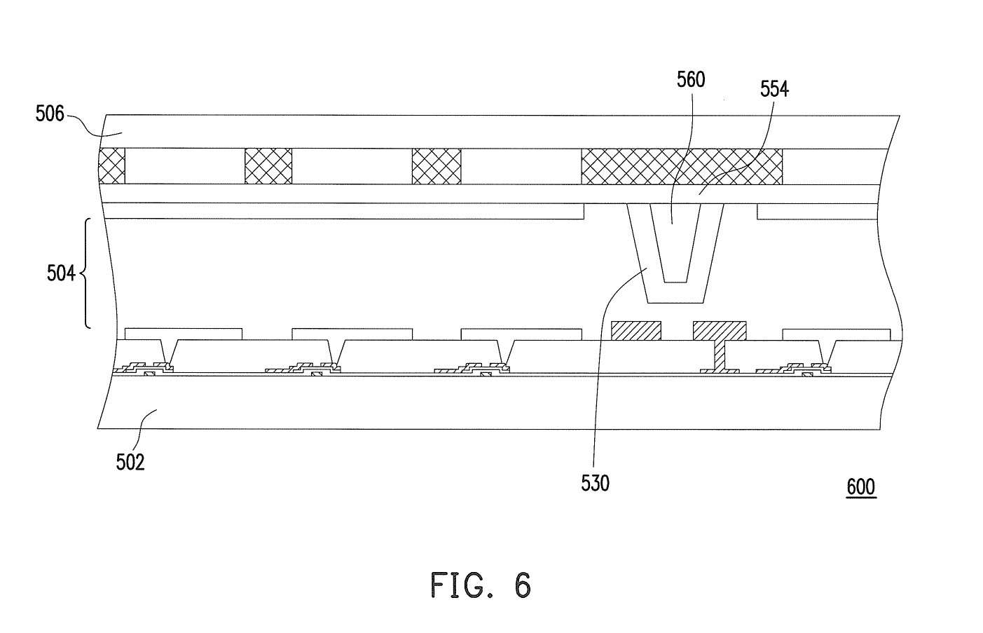

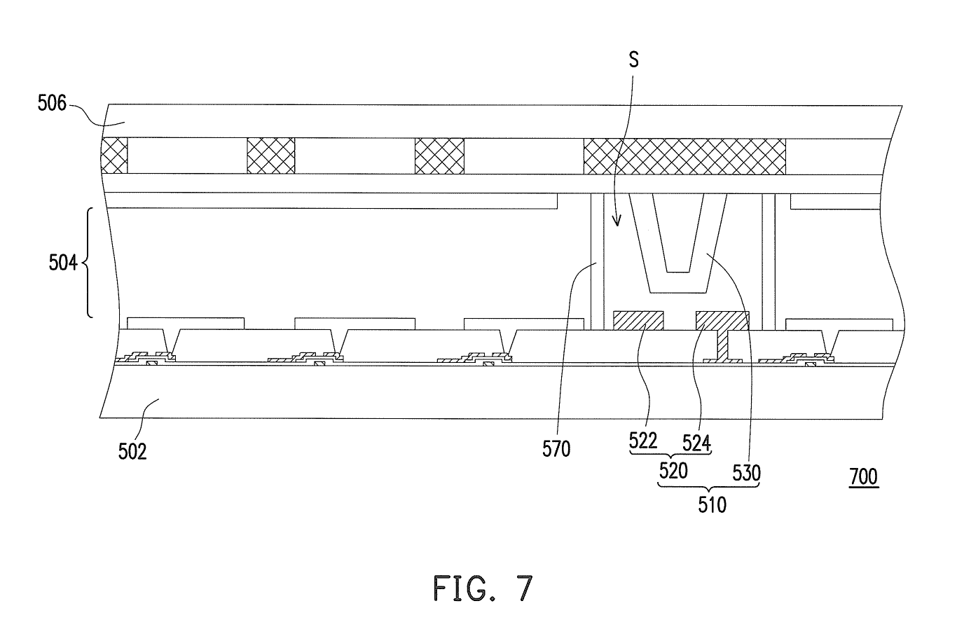

FIG. 5A, FIG. 6 and FIG. 7 are cross-sectional views of three touch display panels according to the embodiment of FIG. 2. Referring to FIG. 5A, a circuit layout of the touch display panel 500 is similar to that of the touch display panel 200. Namely, the touch control method of the touch display panel 500 is substantially the same to that of the touch display panel 200. Therefore, the circuit layout of the touch display panel 500 is simple than that of the conventional touch display panel 100 (shown as FIG. 1), and the touch display panel 500 may have a better display aperture ratio and have the multi-point touch control function.

To be specific, the touch display panel 500 includes a first substrate 502, a liquid crystal layer 504, a second substrate 506, at least a sensing-signal line 508, a touch-sensing device 510, a plurality of scan lines (not shown), a plurality of data lines 514 and a plurality of pixel units 516. The liquid crystal layer 504 is disposed between the first substrate 502 and the second substrate 506. The scan lines (not shown), the data lines 514 and the pixel units 516 are all disposed on the first substrate 502. Here, only one sensing-signal line 508 is illustrated, and the sensing-signal line 508 is disposed on the first substrate 502. The touch-sensing device 510 includes a set of sensing pads 520 and a signal transmission element 530. The set of sensing pads 520 is disposed on the first substrate 502, and includes a first pad 522 and a second pad 524 apart from the first pad 522. The first pad 522 is electrically connected to one of the scan lines (not shown, referring to the first pad 222 of FIG. 2), and the second pad 524 is electrically connected to the sensing-signal line 508 (referring to the second pad 224 of FIG. 2).

Moreover, the signal transmission element 530 is disposed on the second substrate 506. Substantially, a common electrode 552, an insulation layer 554 and a color filter layer 556 are further disposed on the second substrate 506. The common electrode 552 is located between the insulation layer 554 and the liquid crystal layer 504, and is insulated to the signal transmission element 530. The insulation layer 554 is disposed between the color filter layer 556 and the common electrode 552. To be specific, the color filter layer 556 includes a plurality of black matrix patterns 556A and a plurality of color filter patterns 556B. The color filter patterns 556B are disposed between the black matrix patterns 556A, and the signal transmission element 530 is located on a part of the black matrix patterns 556A.

In other embodiments, the color filter patterns 556B are not respectively disposed between the black matrix patterns 556A on the second substrate 506, but disposed on the pixel units 516, respectively. Namely, the touch display panel 500 may have a structure design of color filter on array (COA) or a structure design of array on color filter (AOC). Moreover, the touch display panel 500 further includes devices such as a related control circuit, etc. that are not illustrated in FIG. 5A.

Actually, when a position where the touch-sensing device 510 is located is pressed, the signal transmission element 530 has to directly touch the set of sensing pads 520 to perform the touch sensing. Therefore, the touch display panel 500 further includes a plurality of protrusions 560 disposed on the second substrate 506, wherein the signal transmission element 530 covers the protrusion 560. Moreover, the insulation layer 554 on the second substrate 506 is located between the signal transmission element 530 and the protrusion 560. A distance between the signal transmission element 530 and the set of sensing pads 520 can be relatively close due to application of the protrusions 560. Therefore, when the user touches the touch display panel 500, the signal transmission element 530 is easily contacted to the set of sensing pads 520 to achieve the touch control function.

FIG. 5B is a schematic diagram illustrating a touch display panel of FIG. 5A when being pressed. Referring to FIG. 5B, the first pad 522 is electrically connected the scan line (not shown). When the touch display panel 500 is pressed, the signal transmission element 530 directly touches the set of sensing pads 520 (i.e. the first pad 522 and the second pad 524). Therefore, the corresponding scan signal can be transmitted to the sensing-signal line 508 through the first pad 522, the signal transmission element 530 and the second pad 524 to implement the touch sensing.

Actually, the signal transmission element 530 and the common electrode 522 can be simultaneously fabricated, and the signal transmission element 530 is, for example, a transparent conductive layer. The first pad 522 and the second pad 524 can be simultaneously fabricated with the pixel unit 516. In other words, fabrication processes of the first pad 522, the signal transmission element 530 and the second pad 524 can be integrated to a fabrication process of the conventional liquid crystal panel. Therefore, the touch-sensing device 510 applied in the liquid crystal panel does not complicate the fabrication process thereof, but can effectively improve an operation convenience of the liquid crystal panel. Moreover, application of the touch-sensing device 510 simplifies the circuit layout of the touch display panel 500, and avails increasing the display aperture ratio of the touch display panel 500.

Next, referring to FIG. 6, the touch display panel 600 and the touch display panel 500 are substantially the same, and a difference there between is that in the touch display panel 600, the protrusion 560 is located between the signal transmission element 530 and the insulation layer 554. Moreover, in the touch display panels 500 and 600 of FIG. 5A and FIG. 6, the signal transmission element 530 is, for example, the transparent conductive layer. In other embodiments of the present invention, the signal transmission element 530 can also be fabricated according to other approaches. For example, in the other embodiments, the signal transmission element 530 can be a conductive plastic not covering the protrusion 560, or can be disposed on the second substrate 560 according to other methods.

Further, referring to FIG. 7, the touch display panel 700 and the touch display panel 600 are substantially the same, and a difference there between is that the touch display panel 700 further includes block wall patterns 570 surrounding the signal transmission element 530 and the set of sensing pads 520. The block wall patterns 570 are disposed between the first substrate 502 and the second substrate 506. The block wall patterns 570, the first substrate 502 and the second substrate 506 commonly enclose a closed space S to prevent the liquid crystal layer 504 from contacting the sensing pads 520.

During an actual application, a material of the block wall pattern 570 is, for example, an elastic material, and the block wall patterns 570 are, for example, fabricated on the first substrate 502 or the second substrate 506 before the liquid crystal layer 504 is formed. Therefore, the closed space S is not filled with liquid crystal molecules, which avails improving a sensitivity of the touch-sensing device 510. When a position where the touch-sensing device 510 is located is pressed, none obstacle such as the liquid crystal molecule, etc. is existed between the signal transmission element 530 and the set of sensing pads 520. Therefore, the signal transmission element 530 is easy to directly contact the set of sensing pads 520, so as to improve the sensitivity of the touch-sensing device 510. Certainly, the block wall patterns 570 can also be configured to the touch display panel 500 of FIG. 5A.

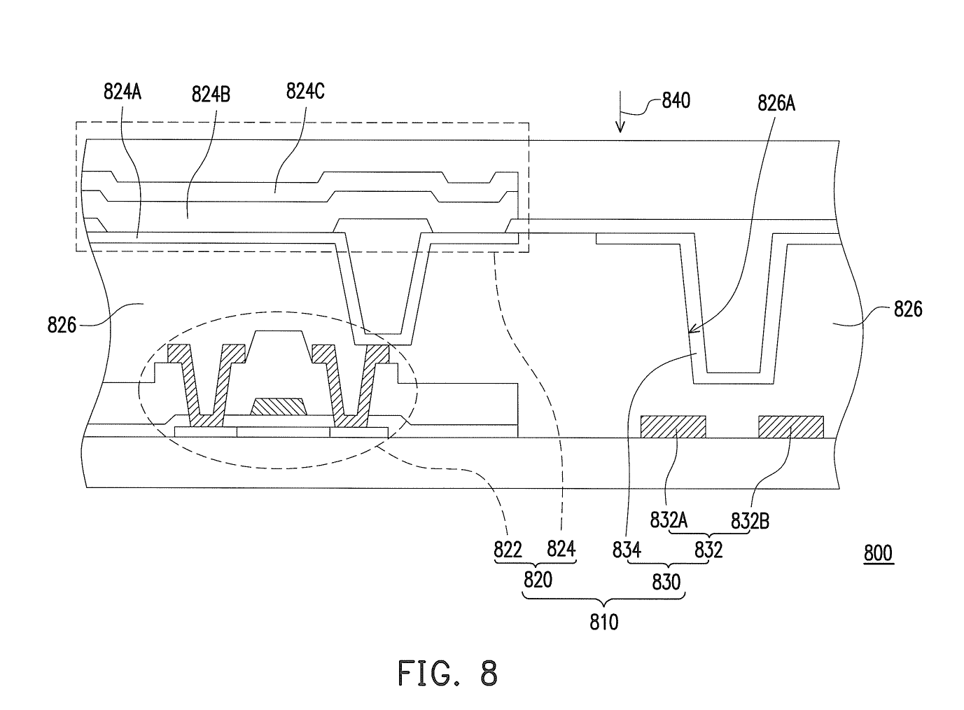

FIG. 8 is a schematic diagram of a touch display panel according to another embodiment of the present invention. Referring to FIG. 8, the touch display panel 800 is substantially designed according to the circuit layout of the touch display panel 200 of the aforementioned embodiment. Here, a sensing unit 810 including a pixel unit 820 used for displaying an image, and a touch-sensing device 830 used for performing the touch sensing is taken as an example for description. The pixel unit 820 is, for example, disposed on a substrate (not shown). Certainly, the touch display panel 800 further includes devices such as scan lines, data lines, sensing-signal lines and a related control circuit, etc. that are not illustrated in FIG. 8.

Each of the touch-sensing devices 830 includes a set of sensing pads 832 and a signal transmission element 834. The set of sensing pads 832 includes a first pad 832A and a second pad 832B apart from the first pad 832A, and the signal transmission element 834 is located above the set of sensing pads 832. When a position where the touch-sensing device 830 is located is pressed, the signal transmission device 834 can directly contact the first pad 832A and the second pad 832B, and when the position where the touch-sensing device 830 is located is unpressed, the signal transmission element 834 is isolated to the first pad 832A and the second pad 832B. Therefore, the touch sensing operation of the touch display panel 800 is actually determined by whether or not the signal transmission element 834 is electrically connected to the set of sensing pads 832.

In the present embodiment, each of the pixel units 820 includes an active device 822 and a light-emitting device 824. The active device 822 is electrically connected to one of the scan lines and one of the data lines that are not illustrated, and the light-emitting device 824 is located on the active device 822 and is electrically connected to the active device 822. The light-emitting device 824 at least includes a first electrode 824A, a light-emitting material layer 824B and a second electrode 824C, and the first electrode 824A is electrically connected to the active device 822. Moreover, the light-emitting device 824 is not limited to the above three-layer structure, and the light-emitting device 824 can also be a structure with more than three layers. Actually, the display panel 800 is an organic electro-luminescence display panel (OLED panel). In the present embodiment, the first electrode 824A provides a function similar to that provided by the pixel electrode 206B of the touch display panel 200. By turning on the active device 822, the first electrode 824A may have a specific voltage to display images.

The touch display panel 800 further includes a planarization layer 826 disposed between the active device 822 and the light-emitting device 824. Actually, the planarization layer 826 can further be disposed between the signal transmission element 834 and the set of sensing pads 832 to avoid an unnecessary conduction between the signal transmission element 834 and the set of sensing pads 832. Meanwhile, to maintain a normal operation of the touch-sensing device 830, a material of the planarization layer 826 is, for example, a flexible insulation material. Further, to shorten a distance between the signal transmission element 834 and the set of sensing pads 832, the planarization layer 826 may have a plurality of grooves 826A, and the signal transmission element 834 is at least located in the grooves 826A. Wherein, a depth of the groove 826A of the planarization layer can reach the set of sensing pads 832, so that the first pad 832A and the second pad 832B are exposed and are not covered by the planarization layer 826. Therefore, none obstacle is existed between the signal transmission element 834 and the set of sensing pads 832, so that a better sensitivity is achieved when the touch sensing is performed. When the user performs a touch operation, the user presses the touch display panel 800 along a direction of an arrow 840. Now, the flexible planarization layer 826 is squeezed, so that the signal transmission element 834 contacts the set of sensing pads 832 to perform the touch sensing operation.

Actually, the first electrode 824A and the signal transmission element 834 are in a common layer, or made of the same film. To maintain independent device characteristics of the pixel unit 820 and the touch-sensing device 830, the first electrode 824A and the signal transmission element 834 are mutually insulated, preferably. In an embodiment, a material of the first electrode 824A is molybdenum, molybdenum alloy or a combination thereof, while other materials having the same function can also be applied, which is not limited by the present invention. Meanwhile, a material of the second electrode 824C can be a transparent conductive material. Namely, in the touch display panel 800 of the present embodiment, light emitted from the light-emitting material layer 824B can pass through the second electrode 824C and emit out. In other words, a side of the touch display panel 800 pointed by the arrow 840 is a display surface of the touch display panel 800. It should be noted that when the material of the first electrode 824A has a reflective characteristic, the first electrode 824A can reflect the light, which avails improving a display brightness of the touch display panel 800. In the present embodiment, each of the touch-sensing devices 830 can correspond to one pixel unit 820 (as shown in FIG. 8), or a plurality of the pixel units 820 may share one corresponding touch-sensing device 830. For example, three pixel units of R, G and B share one corresponding touch-sensing device 830 and one corresponding sensing-signal line 208 (not shown).

Since additional connection of touch scan lines and a related control circuit is unnecessary for the touch-sensing device 830, the circuit layout of the touch display panel 800 can be simplified. Moreover, an area of the touch-sensing device 830 is substantially equal to an area of the set of sensing pads 832, and the set of sensing pads 832 is only composed of two pads (832A and 832B). Therefore, configuration of the touch-sensing device 830 is not liable to decrease the display aperture ratio of the touch display panel 800, but can improve a display effect of the touch display panel 800.

In summary, the touch display panel of the present invention has at least the following advantages. In the present invention, the scan lines of the pixel units and the scan lines of the touch-sensing devices can be shared. Therefore, though the touch display panel is integrated with functions of image display and multi touch control, it can still have a simple circuit layout. Moreover, in the touch display panel of the present invention, a design of the touch-sensing device is simple, and an area thereof is relatively small, so that the touch display panel may have a better display effect.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch display panel, comprising:
a first substrate;
a second substrate, disposed in parallel to the first substrate;
a plurality of scan lines, disposed on the first substrate;
a plurality of data lines, disposed on the first substrate, and the plurality of data lines is intersected to the plurality of the scan lines;
a plurality of pixel units, disposed on the first substrate, and electrically connected to the plurality of scan lines and the plurality of data lines;
at least a sensing-signal line, disposed on the first substrate, and located between two adjacent pixel units that are belonging to the plurality of pixel units;
at least a touch-sensing device, the touch-sensing device comprising:
a set of sensing pads, disposed on the first substrate, and the set of sensing pads comprising a first pad and a second pad apart from the first pad, wherein the first pad is electrically connected to one of the plurality of scan lines, and the second pad is electrically connected to the sensing-signal line; and
a signal transmission element, disposed on the second substrate, and located above the set of sensing pads; and
at least a protrusion, disposed on the second substrate, and the signal transmission element covers the protrusion,
wherein when a position where the touch-sensing device is disposed is pressed, the signal transmission element directly contacts the first pad and the second pad, and when the position where the touch-sensing element is disposed is unpressed, the signal transmission element is insulated to at least one of the first pad and the second pad.

2. The touch display panel as claimed in claim 1, further comprising an insulation layer and a common electrode disposed on the second substrate, wherein the common electrode is disposed between the insulation layer and a liquid crystal layer, and the common electrode is isolated to the signal transmission element.

3. The touch display panel as claimed in claim 2, further comprising a plurality of black matrix patterns disposed on the second substrate, wherein the insulation layer is disposed between the plurality of black matrix patterns and the common electrode and the signal transmission element is located on a part of the black matrix patterns.

4. The touch display panel as claimed in claim 3, further comprising a plurality of color filter patterns, wherein the plurality of color filter patterns is respectively located between the plurality of black matrix patterns.

5. The touch display panel as claimed in claim 2, further comprising at least a block wall pattern disposed between the first substrate and the second substrate, and the block wall pattern surrounding the touch-sensing device to prevent the liquid crystal layer from contacting the sensing pads.

6. The touch display panel as claimed in claim 1, wherein the protrusion is disposed between the signal transmission element and the insulation layer.

7. The touch display panel as claimed in claim 1, wherein the insulation layer is disposed between the signal transmission element and the protrusion.

8. The touch display panel as claimed in claim 1, wherein each of the pixel units comprises an active device that is electrically connected to one of the scan lines and one of the data lines.

9. The touch display panel as claimed in claim 1, further comprising a liquid crystal layer disposed between the first substrate and the second substrate.

10. The touch display panel as claimed in claim 1, wherein each of the pixel units comprises an active device and an organic light-emitting diode, the active device is electrically connected to one of the scan lines and one of the data lines, and the organic light-emitting diode is located on the active device and is electrically connected to the active device.

11. The touch display panel as claimed in claim 10, further comprising a planarization layer disposed between the first substrate and the second substrate, and located between the active device and the light-emitting diode, wherein a material of the planarization layer is a flexible insulation material.

12. The touch display panel as claimed in claim 11, wherein the planarization layer has a plurality of grooves located above the set of sensing pads, and each of the signal transmission elements is located in one of the corresponding grooves.

13. The touch display panel as claimed in claim 10, wherein the organic light-emitting diode at least comprises a first electrode, a light-emitting material layer and a second electrode, and the first electrode is electrically connected to the active device.

14. The touch display panel as claimed in claim 13, wherein the first electrode and the signal transmission element are in a common layer, the first electrode is electrically isolated to the signal transmission element, and a material of the second electrode is a transparent conductive material.
